(19) United States
(12) Patent Application Publication
(10) Pub. No.: US 2003/0135393 A1
(43) Pub. Date: Jul. 17, 2003

(54) System, method and computer program product for improving treatment of medical patients

(75) Inventor: Richard Burgess, Raleigh, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Laboratory Corporation of America Holdings, Research Triangle Park, NC

(21) Appl. No.: 10/044,725

(22) Filed: Jan. 11, 2002

(51) Int. Cl. G06F 17/60

(52) U.S. Cl. 705/3

(57) ABSTRACT

A system, method and computer program product for improving treatment of medical patients aids a user, such as a treating physician, by providing access to an expert consult request form and/or pharmaceutical information directly from a patient medical report. The system includes at least one processing element with a patient medical report including medical information. The patient medical report is associated with at least one expert consult request form and/or at least one pharmaceutical product report, which are accessible directly from the patient medical report. Upon access, the processing elements are capable of populating the expert consult request forms with a portion of the medical information from the patient medical report. The system also includes at least one expert processing element that is capable of receiving the expert consult request forms to thereby facilitate a medical consultation at least partially based upon the expert consultation request forms.

### FIELD OF THE INVENTION

The present invention relates generally to medical services and, more particularly, to systems for improving treatment of medical patients.

### BACKGROUND OF THE INVENTION

As treatment regimens for medical patients become more complicated and the number of treatment choices increases, physicians continue to seek out tools and methods which better organize and display pertinent information to facilitate optimal treatment decisions for patients. For example, with respect to a patient infected with the Human Immunodeficiency Virus (HIV), physicians often utilize sophisticated genotype and phenotype reports. These reports can be presented in electronic form and include a listing of particular medications relevant to treatment of the patient's illness together with an assessment of the extent to which a patient's HIV or the patient himself may be sensitive or resistant to each medication listed in the report. Such reports are typically used as a tool to assist physicians in the decision-making process regarding an initial drug therapy regimen or potential changes to an existing regimen. In addition to employing sophisticated reporting methods, treating physicians increasingly need easy and timely access to detailed pharmaceutical information, such as may be provided by a pharmaceutical company sales representative or a peer-reviewed journal article.

Whereas reporting methods aid in the decision making process, many physicians consider interpretation of such reports to be difficult, leading to a consensus within the medical community that advanced reports, such as HIV genotyping and phenotyping reports, are not optimally utilized in treatment decisions made for patients.

Conventionally, many physicians who desire to utilize sophisticated reporting methods, but find them too complicated to interpret, request expert medical consultations or recommendations to assist in the making of a treatment decision for a particular patient. Requesting physicians may complete paper consultation request forms containing information relative to the particular patient and the respective report, such as a genotype or phenotype report. These conventional paper consultation request forms are then sent, typically by mail or facsimile, to a medical expert. The medical expert then interprets the information contained on the paper consultation request form and thereafter returns, typically by mail or facsimile, a written consultation or recommendation concerning potential treatment options for the patient.

Utilizing paper consultation request forms may provide an adequate method of obtaining an expert consultation, however, it has fundamental drawbacks. In this regard, paper consultation request forms are inefficient, time consuming and can potentially include inaccuracies. For example, paper consultation request forms require the requesting physician to copy information from multiple sources, including the sophisticated medical reports, onto the paper request form. This process creates an unnecessary and disadvantageous risk of a multitude of errors, including transcription errors, omission errors and transmission errors (e.g., failure of mail and or facsimile delivery).

To receive detailed, up to date pharmaceutical information, such as information relating to medications referenced in medical reports, physicians typically must access disparate data sources outside traditional medical reference texts. In this regard, treating physicians must typically acquire such information by, for example, consulting a pharmaceutical representative, a drug reference manual, or accessing journal articles. As an alternative, physicians also may be able to log on to an Internet site such as those provided by pharmaceutical companies and search for the desired information.

Like paper consultation request forms, conventional methods of acquiring pharmaceutical product information also suffer from fundamental drawbacks. These conventional methods of acquiring pharmaceutical product information can be time consuming and ineffective for the physician. Actively acquiring the desired pharmaceutical product information by consulting a pharmaceutical representative or logging on to a secure Internet site requires unnecessary effort on the part of the physician because such methods are out of context for the physician and not within the normal workflow of making a pharmaceutical prescribing decision.

### SUMMARY OF THE INVENTION

In light of the foregoing background, the present invention provides a system, method and computer program product for improving treatment of medical patients. The system, method and computer program product of the present invention aid users, such as treating physicians, in the treatment of patients by providing access to expert consult request forms and/or a pharmaceutical product report directly from a patient medical report. Advantageously, by providing direct access to the expert consult request form, which is preferably in electronic form, most of the information typically contained within conventional paper consultation request forms can be automatically populated into the expert consult request form. As such, the present invention reduces the opportunity for errors caused by the use of conventional paper consultation request forms.

Transcription errors and omissions errors are reduced because the requisite medical information can be automatically populated into the medical consultation form. For example, with respect to genotype and phenotype reports, patient viral load and CD4 (T-cell) count information can be populated into the expert consult request form. Additionally, by utilizing an expert consult request form in electronic form, the expert consult request form is easier to complete than conventional paper consultation request forms because the user does not need to enter as much information, and because the expert consult request form can be transmitted to a medical expert electronically. Moreover, the expert consult request form facilitates the use of artificial intelligence and expert systems to provide medical consultations, in addition to the use of medical experts.

By providing access to the pharmaceutical product report directly from the patient medical report, the present invention allows the user to easily request pharmaceutical information contained within the pharmaceutical product report. Advantageously, a user such as the treating physician can access the pharmaceutical product report within the context of the patient medical report to assist in the decision-making process regarding new, or changes in, drug therapy regimens for particular patients. The present invention also allows the pharmaceutical product report to be customized for particularities in the treatment regimen of the patient. For example, the electronic pharmaceutical product report can be customized for a particular genetic mutation to account for viral mutations indicated on a genotype report.

According to one aspect of the present invention, a system for improving treatment of medical patients includes at least one request processing element and at least one expert processing element. The request processing elements comprise a patient medical report that includes medical information and is associated with at least one expert consult request form. Advantageously, as stated, the expert consult request forms are accessible directly from the patient medical report. For example, the patient medical report also can include at least one expert consult pointer that is associated with the expert consult request forms such that the request processing elements are responsive to a selection of at least one expert consult pointer to thereby display an associated expert consult request form.

Also, advantageously, the request processing elements are capable of populating the expert consult request forms with a portion of the medical information from the patient medical report, which reduces the opportunities for the transcription errors associated with conventional paper consultation request forms. In this regard, the system can further include at least one database capable of storing the medical information such that the request processing elements are capable of retrieving the medical information from the databases. To receive the medical information, the expert consult request forms can include at least one medical information field into which the medical information is populated. Also, the expert consult request forms can include at least one input field. In such embodiments, the request processing elements are capable of receiving patient information into the input fields.

The expert processing elements are capable of receiving the expert consult request forms to thereby facilitate a medical consultation at least partially based upon the expert consult request forms. In this regard, the request processing elements can be capable of transmitting the expert consult request forms to the expert processing elements. The expert processing elements can facilitate the medical consultation by displaying at least one medical consultation form based upon the expert consult request forms and thereafter receiving consultation information into the medical consultation forms to complete the medical consultation forms.

The medical consultation forms can include a portion of the medical information from the patient medical report. Additionally, or alternatively, the expert consult request forms can include at least one input field, into which the expert processing element can receive patient information. To provide the medical consultation, the expert processing element is capable of transmitting the at least one completed medical consultation form to thereby provide the medical consultation.

In operation, the patient medical report including the medical information is displayed, such as by the request processing element. Then, at least one expert consult request form is accessed directly from the patient medical report that is displayed. The expert consult request forms are, in turn, populated with at least a portion of the medical information from the patient medical report as the expert consult request forms are accessed. The accessed expert consult request forms are then transmitted and thereafter received. Once the expert consult request forms are received, a medical consultation is generated at least partially based upon the received expert consultation request form.

According to another aspect of the present invention, the patient medical report is associated with at least one pharmaceutical product report including pharmaceutical information, such as marketing information and/or reference information for at least one pharmaceutical product. To allow the user to easily access the pharmaceutical product reports, the pharmaceutical product reports are accessible directly from the patient medical report. For example, the patient medical report can further include at least one pharmaceutical pointer that is associated with the pharmaceutical product reports. Also, the request processing element may be capable of receiving information into the pharmaceutical product reports and thereafter storing and/or transmitting the information.

In embodiments including the pharmaceutical pointers, the request processing elements are responsive to a selection of at least one pharmaceutical pointer to thereby retrieve a respective portion of the pharmaceutical information and display the respective pharmaceutical product report. In this regard, according to this aspect of the present invention, the databases are capable of storing the pharmaceutical information such that the request processing elements are capable of retrieving at least a portion of the pharmaceutical information from the databases as the pharmaceutical product reports are accessed.

In operation, according to one aspect of the present invention, after the patient medical report including medical information is displayed, the pharmaceutical product reports are accessed. Next, at least a portion of the associated pharmaceutical information is retrieved, such as from the databases. The pharmaceutical product reports, including the retrieved portion of the associated pharmaceutical information, are then displayed, such as by the request processing element.

In addition to the system and method for improving treatment of medical patients, the present invention also provides associated computer program products for improving treatment of medical patients.

Summarily, the system, method and computer program product of the present invention aid users in the treatment of patients by providing access to expert consult request forms and/or pharmaceutical product reports directly from a patient medical report. By providing direct access to the expert consult request form, medical information can be automatically populated into the expert consult request form, thus reducing the opportunity for transcription errors. Also, expert consult request forms in electronic form do not require the user to enter as much information as conventional paper consultation request forms. Additionally, electronic expert consult request forms allow the user to transmit the expert consult request form to a medical expert electronically. By providing access to the pharmaceutical product reports directly from the patient medical report, the system, method and computer program product of the present invention allow the user to easily request pharmaceutical information within the context of the patient medical report that the user would typically otherwise use in the decision-making process regarding new, or changes in, drug therapy regimens for particular patients.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a system for improving treatment of medical patients according to one embodiment of the present invention;

FIG. 2 illustrates an expert consult request form according to one embodiment of the present invention;

FIG. 3 illustrates a pharmaceutical product report according to one embodiment of the present invention;

FIG. 4 illustrates a medical consultation form according to one embodiment of the present invention;

FIG. 5 is a flow chart illustrating steps in a method of improving treatment of medical patients according to one embodiment of the present invention;

FIG. 6 is another flow chart illustrating steps in a method of improving treatment of medical patients according to one embodiment of the present invention;

FIG. 7 is a display illustrating an exemplar medical report according to one embodiment of the present invention for improving treatment of HIV patients;

FIG. 8 is a display illustrating an exemplar portal display for accessing expert consult request forms according to one embodiment of the present invention for improving treatment of HIV patients;

FIG. 9 is a display illustrating an exemplar expert consult request form for an initial treatment consultation according to one embodiment of the present invention for improving treatment of HIV patients;

FIG. 10 is a display illustrating an exemplar expert consult request form for a virologic failure salvage therapy consultation according to one embodiment of the present invention for improving treatment of HIV patients;

FIG. 11 is a display illustrating an exemplar expert consult request form for a toxicity problem consultation according to one embodiment of the present invention for improving treatment of HIV patients;

FIG. 12 is a display illustrating an exemplar pharmaceutical product report according to one embodiment of the present invention for improving treatment of HIV patients;

FIG. 13 is a display illustrating an another exemplar pharmaceutical product report including a further element according to one embodiment of the present invention for improving treatment of HIV patients;

FIG. 14 is a display illustrating an exemplar electronic expert consultation portal according to one embodiment of the present invention for improving treatment of HIV patients;

FIG. 15 is a display illustrating an exemplar electronic profile according to one embodiment of the present invention for improving treatment of HIV patients;

FIG. 16 is a display illustrating an exemplar medical consultation form for an initial treatment consultation according to one embodiment of the present invention for improving treatment of HIV patients;

FIG. 17 is a display illustrating an exemplar medical consultation form for a virologic failure salvage therapy consultation according to one embodiment of the present invention for improving treatment of HIV patients; and

FIG. 18 is a display illustrating an exemplar medical consultation form for a toxicity problem consultation according to one embodiment of the present invention for improving treatment of HIV patients.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

### Overview: System for Improving Treatment of Medical Patients

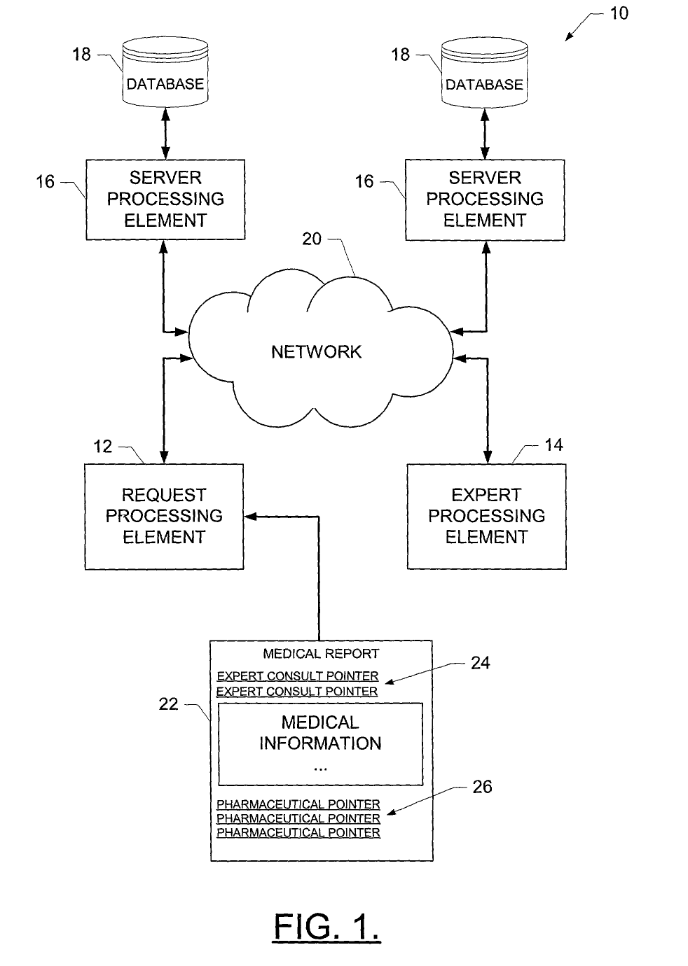

Referring to FIG. 1, a system 10 for improving treatment of medical patients includes at least one request processing element 12, at least one expert processing element 14 and at least one server processing element 16, with each server processing element including a database 18. Although FIG. 1 only depicts one request processing element, one expert processing element and two server processing element including a database, it should be understood that the system can include multiple request processing elements, expert processing elements and server processing elements without departing from the spirit and scope of the present invention.

In one scenario, each request processing element is associated with one of a plurality of treating physicians, while each expert processing element is associated with one of a plurality of medical experts, and each server processing element (including a database) are associated with one of a plurality of different information. Alternatively, each request processing element and expert processing element can be associated with a plurality of treating physicians and medical experts, respectively. In instances where the request processing element or expert processing element is associated with more than one treating physician or medical expert, respectively, any one of a number of methods can be employed to distinguish one treating physician or medical expert from another. For example, each treating physician and medical expert could be associated with a unique user ID that the request processing element or expert processing element could use to identify the respective treating physician or medical expert.

The request and expert processing elements can each comprise any one of a number of devices, such as personal computers or other high level processors, as such are known to those skilled in the art. Similarly, the server processing elements can comprise any of a number of devices, such as server computers or other high level processors. Although the request processing elements, expert processing elements and server processing elements are illustrated and described herein as being separate and distinct elements, it should be understood that any one of the elements can perform the functions of any one of the other elements without departing from the spirit and scope of the present invention. For example, one or more expert processing elements can perform the functions of one or more server processing elements, and vice versa. In this regard, it also should be understood that in embodiments where either a request processing element or an expert processing element performs the functions of at least one server processing element, the respective request processing element or expert processing element will include a database.

The request processing elements 12, expert processing elements 14 and server processing elements 16 (including the databases 18) are capable of communicating via a network 20. The network can comprise any of a number of different networks, including a local area network (LAN), a metropolitan area network (MAN) and/or a wide area network (WAN). In a preferred embodiment, however, the network comprises a WAN, such as the Internet, that allows the request processing elements, expert processing elements and server processing elements to communicate with one another while located remote from one another at distances ranging from next to one another to across a continent or farther.

As shown, the server processing elements 16 each include a database 18. The databases, which can comprise any of a number of known devices, store information such medical information and pharmaceutical information. The medical information can be referenced in the databases in any one of a number of different manners but, in one embodiment, the medical information is associated with and identified by a reference identifier. The medical information can comprise any number of different types of medical information, including medical information relating to particular patients, such as the results from tests performed on one or more specimens, or samples, taken from respective patients and/or an analysis of such results. Additionally, or alternatively, the medical information can include past and present patient information, such as patient diagnoses and medications taken by and/or prescribed to the patient. The medical information can be formatted in any one of a number of different manners, including a text format, a graphical format such as computer generated and computer scanned documents and/or a multimedia format such as video clips.

The pharmaceutical information likewise can comprise any number of different types of pharmaceutical information. Preferably, however, the pharmaceutical information includes information relating to at least one pharmaceutical company and/or at least one pharmaceutical product or medication, such as reference and/or commercial information. For example, the pharmaceutical information can comprise reports of clinical studies concerning pharmaceutical products, multimedia streams of pharmaceutical product marketing information and/or questions associated with a pharmaceutical company sponsored survey. Like the medical information, the pharmaceutical information can be formatted in any one of a number of different manners, including a text format, a graphical format such as computer generated and computer scanned documents and/or a multimedia format such as video clips.

The request processing elements 12 are capable of displaying an electronic medical report 22, including at least a portion of the medical information stored in the databases 18. For example, one type of medical report may comprise a medical laboratory report, such as a genotype report, phenotype report or the like. In this regard, the request processing elements display the medical report on an apparatus for allowing a user to view displayed data or other information such as, for example, a viewing screen or monitor. To associate the portion of the medical information to the medical information stored in the databases, the medical report is associated with the reference identifier that identifies the respective medical information. The medical report can be in any of a number of different formats, including a portable document format (PDF) and/or a hypertext markup language format (HTML). In one typical scenario of generating a medical report, a treating physician first collects a blood sample from a patient. Next, a medical laboratory performs at least one test on the sample and stores the results of the test(s) in one or more databases utilizing the respective server processing elements 16. The medical reports are then generated from the results of the test(s), and thereafter transmitted back to the treating physician, such as via the network 20 by email, an electronic medical records system or the like.

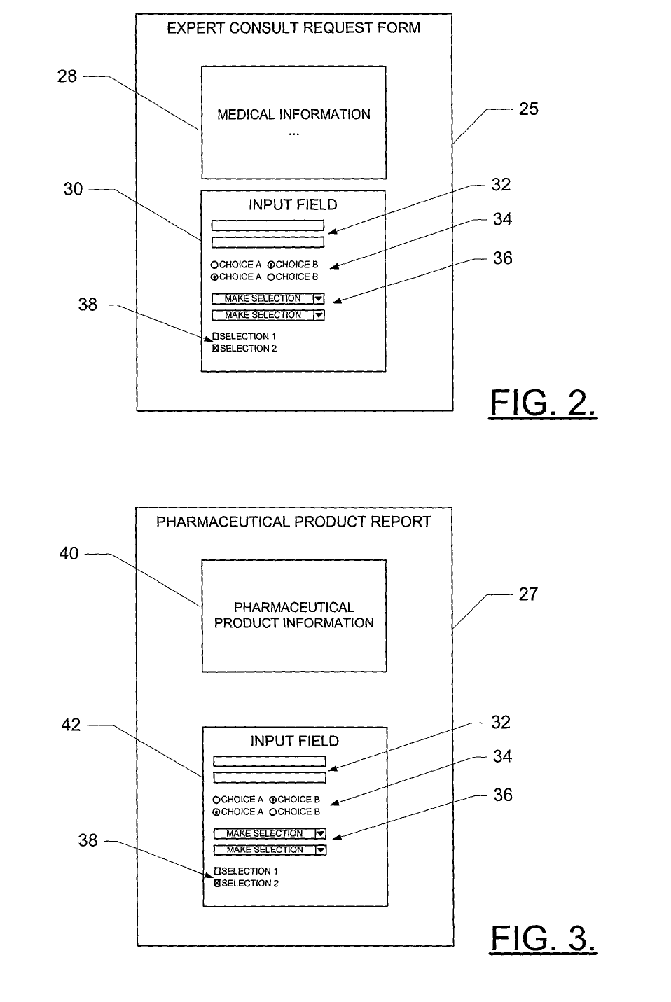

Upon viewing the medical report 22, a user, such as a treating physician, could desire to seek additional information to improve treatment of a respective patient, such as an expert medical consultation and/or pharmaceutical product information. As such, the medical report includes at least one expert consult pointer 24 and at least one pharmaceutical pointer 26. The expert consult pointers, when selected or otherwise executed, allow the user to request a medical consultation directly from the medical report. In this regard, the expert consult pointers identify and are associated with at least one electronic expert consult request form 25 (see FIG. 2). The expert consult pointers can comprise any number of different elements, such as hypertext links or other defined “hot spots,” hyperlinks or the like, as such are known to those skilled in the art.

Similar to the expert consult pointers 24, the pharmaceutical pointers 26, when selected or otherwise executed, allow the user to view pharmaceutical information. In this regard, the pharmaceutical pointers identify and are associated with at least one electronic pharmaceutical product report 27 (see FIG. 3). The pharmaceutical product reports are, in turn, preferably associated with pharmaceutical information for at least one pharmaceutical product. Also, like the expert consult pointers, the pharmaceutical pointers can comprise any number of different elements, such as hypertext links or other defined “hot spots,” hyperlinks or the like.

When at least one expert consult pointer 24 is selected or otherwise executed, the respective request processing element 12 is capable of displaying a respective expert consult request form 25, now referring to FIG. 2. Like the medical report, the expert consult request form can be in any of a number of different formats, including a portable document format (PDF) and/or a hypertext markup language format (HTML). The request processing element can directly display the expert consult request form upon execution of the expert consult pointer but, in one embodiment, the request processing element first displays an electronic request form portal (not shown) upon execution of the expert consult pointer. In this embodiment, the expert consult pointer is associated with and identifies the electronic request form portal. The electronic request form portal includes request form pointers that, in turn, identify and are associated with the expert consult request forms. Upon execution of a request form pointer, the request processing element displays the expert consult request form.

The expert consult request form 25 generally includes a medical information field 28 and at least one input field 30. Upon display of the expert consult request form, the respective request processing element 12 retrieves at least a portion of the medical information contained within the medical report 22 from the respective databases 18, such as via the reference identifier associated with the respective medical report and identifying the medical information. After retrieving the medical information, the request processing element automatically populates the medical information field with the respective medical information, such a by matching the medical information field with the retrieved medical information. In one typical scenario, the portion of medical information populated into the medical information fields include only that portion of medical information necessary to request a medical consultation, such as the results of a medical test.

In addition to the medical information field 28, the expert consult request form 25 includes the input fields 30. The request processing elements 12 are capable of receiving additional information into the input fields, such as patient information used to supplement the medical information populated into the medical information field. As used herein unless specified otherwise, the request processing elements 12, as well as the expert processing elements 14 and server processing elements 16, receive information via an input device to the respective processing element, such as a keyboard, mouse, personal digital assistant (PDA) or the like. The additional information can include information not stored in the databases 18, as well as information more up-to-date than that stored in the databases. The additional information can be received into the input fields in any number of different manners, including via text box fields 32, radio button groups 34, pull-down list fields 36 and/or checkbox fields 38, as such are known to those skilled in the art.

Referring to FIG. 3, when at least one pharmaceutical pointer 26 is selected or otherwise executed, the respective request processing element 12 is capable of displaying a respective pharmaceutical product report 27. The pharmaceutical product report generally includes at least one pharmaceutical product information field 40. Before displaying the pharmaceutical product report, the request processing element retrieves at least a portion of the pharmaceutical information for a pharmaceutical product associated with the pharmaceutical product report from the respective databases 18. For example, the request processing element can retrieve the pharmaceutical information from databases operated by or otherwise under the control of at least one pharmaceutical company. The request processing element can retrieve the pharmaceutical information solely based upon the respective pharmaceutical pointer executed. In one advantageous embodiment, however, the request processing element retrieves the pharmaceutical information further based upon the medical information contained within the medical report 22, such as via the reference identifier associated with the respective medical report and identifying the medical information. As such, the pharmaceutical information retrieved is specific to the medical information contained within the medical report, such as pharmaceutical information specific to genetic mutation information included within a genotype report.

After retrieving the pharmaceutical information, the respective request processing element 12 displays the respective pharmaceutical information in the pharmaceutical product information fields 40 of the pharmaceutical product report 27. The pharmaceutical information can be formatted in any one of a number of different manners, including a text format, a graphical format such as computer generated and computer scanned documents and/or a multimedia format such as video clips. In one typical scenario, the portion of pharmaceutical information includes reference and/or commercial information respecting a particular pharmaceutical product, such as a pharmaceutical drug.

In addition to the pharmaceutical product information fields 40, the pharmaceutical product report 26 can include at least one input field 42. As such, the request processing elements 12 are capable of receiving input information into the input fields, such as request or feedback information that can be used by the user and/or a third party, such as a pharmaceutical company. For example, the input fields are capable of receiving requests by treating physicians for product samples, as wells as answers to questions in a pharmaceutical company sponsored survey. Also, for example, the input fields can include an interactive chat session whereby the user can enter text, such as questions and/or feedback, and receive, in real-time, a response from an operator, such as a third party or a pharmaceutical company. Similar to the input fields 30 of the expert consult request form 25, the request processing elements 12 are capable of receiving the input information into the input fields of the pharmaceutical product report in any number of different manners, including via text box fields 32, radio button groups 34, pull-down list fields 36 and/or checkbox fields 38, as such are known to those skilled in the art.

Upon receiving the input information into the input fields 42 of the pharmaceutical product report 27, the respective request processing element 12 can store the input information for later use or transfer. Additionally, or alternatively, the request processing element can transmit the input information. In this regard, the request processing element can transmit the input information to any one of a number of locations, including the databases 18 storing the respective pharmaceutical information and/or one or more other databases, such as databases maintained by a third party.

As stated, upon viewing the medical report 22, the user may desire to seek an expert medical consultation to facilitate treatment of a respective patient. As such, the request processing elements 12 are capable of transmitting a completed expert consult request form. The completed expert consult request form includes the medical information populated into the medical information field 28 and, if received, the additional information in the input fields 30. The completed expert consult request form can be transmitted to at least one expert processing element 14, which is capable of receiving the completed expert consult request form. Additionally or alternatively, one or more server processing elements 16 can receive the completed expert consult request form and thereafter transmit the completed expert consult request form to the respective expert processing elements. It should be understood that in addition to being capable of transmitting the completed expert consult request form, the request processing elements can be capable of locally storing the completed expert consult request form, such as in the respective request processing element in an internal memory, hard disk or the like.

In one typical scenario, a treating physician operating a request processing element transmits the completed expert consult request form to one or more expert processing elements under the control or otherwise associated with one or more medical experts. In this regard, the request processing elements can transmit the completed expert consult request forms to particular ones of the expert processing elements, such as those operated by particular medical expert. For example, the request processing elements can transmit the completed expert consult request forms to particular medical experts based upon the medical information included within the completed expert consult request form and/or a particular type of medical consultation desired.

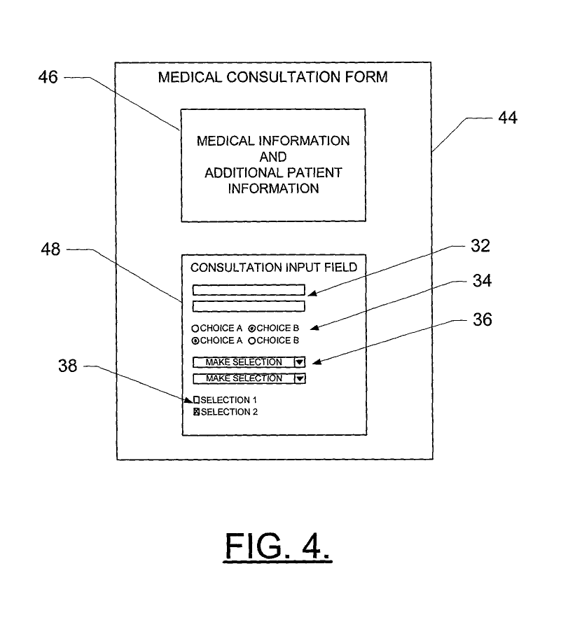

Upon receipt of the completed expert consult request form, the expert processing elements 14 facilitate a medical consultation based at least partially upon the completed expert consult request form. In this regard, the expert processing element is capable of displaying at least one electronic medical consultation form 44 based upon the completed expert consult request form, as shown in FIG. 4. Similar to the request processing element 12, the expert processing elements are capable of displaying the medical consultation form on an apparatus for allowing a user to view displayed data or other information such as, for example, a viewing screen or monitor.

The expert processing elements 14 can directly display the medical consultation forms 44, or the expert processing elements can display an electronic expert consultation portal that includes at least one medical consultation pointer (not shown). In these embodiments, the medical consultation pointers identify and are associated with respective completed expert consult request forms. For example, the electronic expert consultation portal can include medical consultation pointers that identify a respective specimen identifier and type of request associated with the respective completed expert consult request form. Upon selection or otherwise execution of one or more medical consultation pointers, the expert processing element displays the respective medical consultation form.

The medical consultation form 44 generally includes at least one information field 46 that includes the portion of the medical information from the completed expert consult request form, as well as any additional information received by the respective request processing element 12. The medical consultation form also includes at least one consultation input field 48. The consultation input fields allow a user, such as a medical expert, to record a medical consultation at least partially based upon the medical information and additional information contained within the information fields. Like the input fields 30 of the expert consult request form 25 and the input fields 42 of the pharmaceutical product report 27, the expert processing elements 14 can receive the consultation information into the consultation input fields in any number of different manners, including via text box fields 32, radio button groups 34, pull-down list fields 36 and/or checkbox fields 38.

Additionally, or alternatively, the expert processing element 14 can include an expert system, such as an artificial intelligence application using a knowledge base of medical expertise, to facilitate providing the medical consultation. In this regard, such a knowledge base includes a set of rules and data extracted from at least one medical expert through extensive questioning. The artificial intelligence application is then applied for inquiry, manipulation, and response based upon the knowledge base.

By receiving the consultation information, the expert processing elements 14 complete the medical consultation form 44 for subsequent use. In this regard, the expert processing elements 14 are capable of transmitting the completed medical consultation form and, in turn, the request processing elements 12 are capable of receiving the completed medical consultation form. In one typical scenario, after a medical expert has recorded a medical consultation on the medical consultation form, the expert processing element transmits the completed medical consultation form back to the treating physician that requested the medical consultation. As with the request processing elements, in addition to being capable of transmitting the completed medical consultation form, the expert processing elements can be capable of locally storing the completed medical consultation form, such as in the respective expert processing element in an internal memory, hard disk or the like. The request processing elements can receive the completed medical consultation form directly from a respective expert processing element. Alternatively, a server processing element 16 can receive the completed medical consultation form and thereafter transmit the completed expert consult request form to the respective request processing element.

### Detailed Operation: System for Improving Treatment of Medical Patients

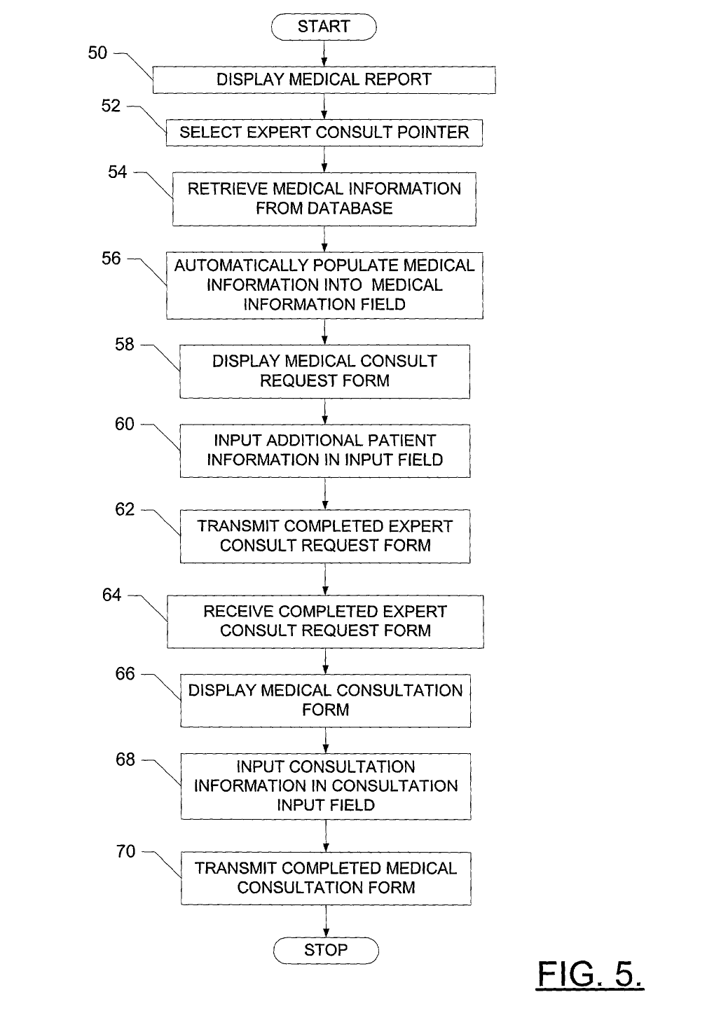

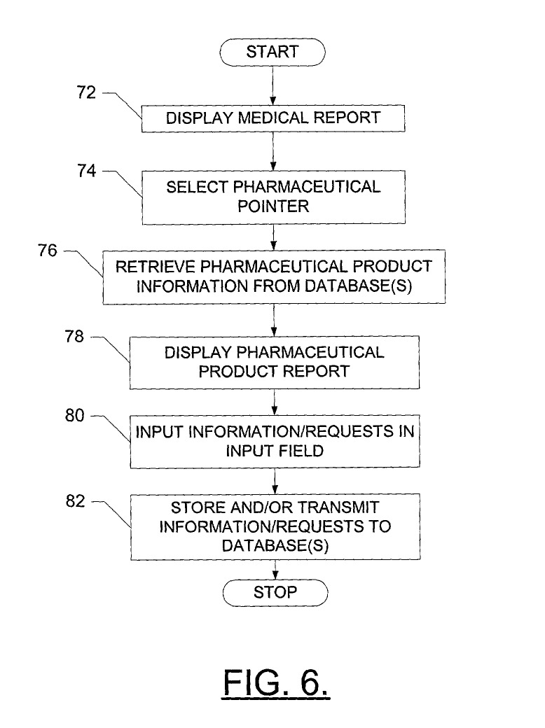

Referring now to FIGS. 5 and 6, operation of the system 10 for improving treatment of medical patients begins with a request processing element 12 displaying the medical report 22, including at least a portion of the medical information stored in the databases 18 (blocks 50, 72). In one scenario, the medical report includes the results of one or more tests performed on a blood sample taken from a patient by a treating physician. In this scenario, the treating physician views the results of the test(s) on the medical report displayed by the request processing element. To request an expert medical consultation directly from the medical report, the user selects an expert consult pointer 24, such as by executing an expert consult pointer comprising a hypertext link (block 52). Similarly, to view pharmaceutical information regarding at least one pharmaceutical product, the user selects a pharmaceutical pointer 26, such as by executing a pharmaceutical pointer comprising a hypertext link (FIG. 6, block 72).

After the expert consult pointer 24 is selected or otherwise executed, the respective request processing element 12 displays a respective expert consult request form 25. In embodiments including the request form portal, the request processing element displays the request form portal including the request form pointers, which identify and are associated with the expert consult request forms. Upon selection or otherwise execution of a request form pointer, the request processing element displays the expert consult request form. To display the expert consult request form 25, the request processing element 12 retrieves at least a portion of the medical information contained within the medical report from the respective databases 18, such as via the reference identifier associated with the respective medical report and identifying the medical information (block 54). After retrieving the portion of the medical information, the request processing element automatically populates the medical information field of the expert consult request form with the respective portion of medical information (block 56). After populating the medical information field, the request processing element displays the expert consult request form (block 58). It should be understood, however, that the medical information field can alternatively be populated either during or after the request processing element displays the expert consult request form without departing from the spirit and scope of the present invention.

Following display of the expert consult request form, the user can input additional information into the input fields 30 of the expert consult request form 25, if so desired (block 60). As such, in one scenario, a treating physician inputs patient information that can be used to supplement the medical information populated into the medical information field. After displaying the expert consult request form and receiving the additional information, if input by the user, the request processing element 12 transmits the completed expert consult request form (block 62). In this regard, the user of the request processing element has requested a medical consultation that can be based at least partially upon the medical information populated into the medical information field and, if submitted and received, the additional information in the input fields.

Following transmission of the completed expert consult request form, the completed expert consult request form is received, such as by at least one expert processing element 14, to thereby facilitate the medical consultation (block 64). Additionally or alternatively, one or more server processing elements 16 can receive the completed expert consult request form and thereafter transmit the completed expert consult request form to the respective expert processing elements.

Upon ultimate receipt of the completed expert consult request form, the expert processing elements 14 can facilitate the medical consultation by first displaying at least one medical consultation form 44 based upon the completed expert consult request form (block 66). In embodiments including the electronic expert consultation portal with the medical consultation pointers, the medical consultation pointers identify and are associated with respective completed expert consult request forms. Upon selection or otherwise execution of one or more medical consultation pointers, the expert processing element displays the respective medical consultation form.

As stated above, the medical consultation form 44 generally includes at least one information field 46 that includes the portion of the medical information from the completed expert consult request form, as well as any additional information received by the respective request processing element 12. In this regard, a user, such as a medical expert, views the medical information and any additional information from the completed expert consult request form to provide a medical consultation. To record or otherwise report the medical consultation, the user inputs consultation information into the consultation input fields 48 of the medical consultation form (block 68). By receiving the consultation information, the expert processing element 14 completes the medical consultation form 44 for subsequent use.

In one preferred embodiment, after receiving the consultation information, the expert processing element 14 transmits the completed medical consultation form, such as to the request processing element 12 that initiated the medical consultation by transmitting the respective completed expert consult request form (block 70). The request processing elements can receive the completed medical consultation form directly from a respective expert processing element. Alternatively, a server processing element 16 can receive the completed medical consultation form and thereafter transmit the completed expert consult request form to the respective request processing element.

Referring to FIG. 6, as stated, if the user desires to view pharmaceutical information regarding at least one pharmaceutical product, the user selects or otherwise executes a pharmaceutical pointer 26 from the medical report 22 to thereby display a respective pharmaceutical product report (block 72). To display the pharmaceutical product report 27, the request processing element 12 retrieves the respective pharmaceutical information from the respective databases 18 (block 76). In embodiments where the request processing element retrieves the pharmaceutical information based further upon the medical information contained within the medical report, the request processing element first retrieves a portion of the medical information from the respective databases storing the relevant medical information. The request processing element then retrieves pharmaceutical information specific to the medical information using the relevant medical information.

After retrieving the pharmaceutical information, the respective request processing element 12 displays the pharmaceutical product report 27 including the pharmaceutical information in the pharmaceutical product information fields 40 of the pharmaceutical product report (block 78). As previously stated, in one typical scenario, the pharmaceutical information includes reference and/or commercial information respecting a particular pharmaceutical product, such as a pharmaceutical drug. In addition to displaying the pharmaceutical product report, the request processing elements can receive input information into the input fields 42 of the pharmaceutical report, if so desired (block 80). In this regard, the user can input requests for product samples, as well as answers to questions in a pharmaceutical company sponsored survey. Additionally, or alternatively, the user can enter into an interactive chat session whereby the user can enter text, such as questions and/or feedback, and receive a response from an operator in real-time.

In one embodiment, upon receiving the input information into the input fields 42 of the pharmaceutical product report 27, the input information is stored for later use or transfer (block 82). Additionally, or alternatively, the request processing element transmits the input information after receiving the input information, such as to the databases 18 storing the respective pharmaceutical information.

### Detailed Operation: Exemplar System for Improving Treatment of HIV Patients

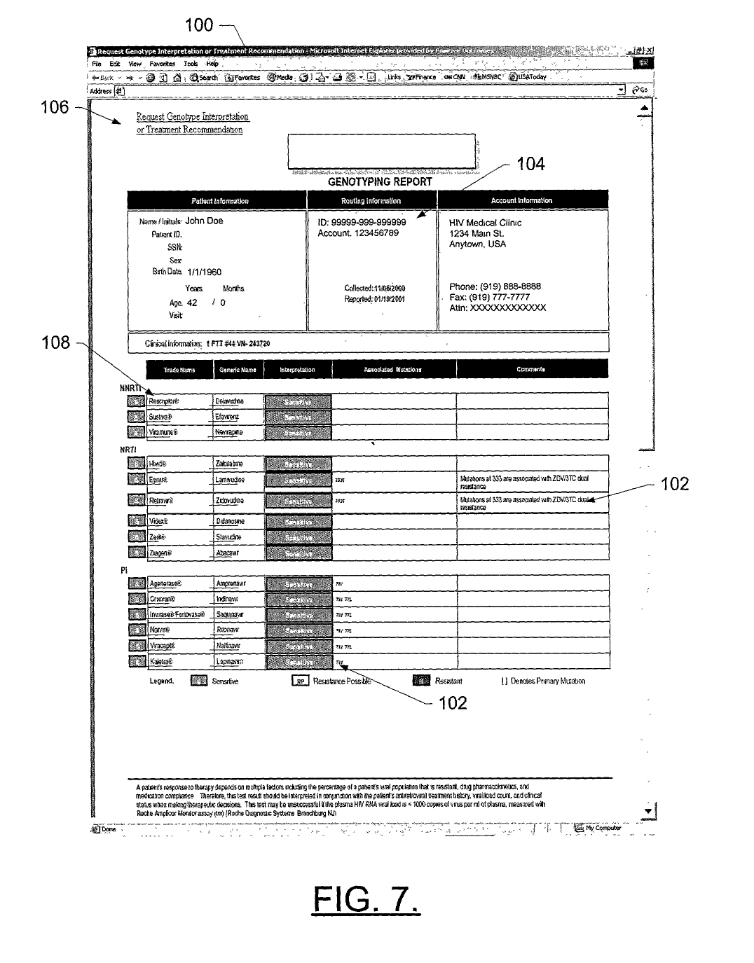

Attention is now drawn to FIGS. 7-18, which illustrate exemplar displays for a system implementing the present invention in the context of a system for improving treatment of HIV patients. It should be understood that FIGS. 7-18 are merely illustrative of one type of application in the context of an exemplar disease and accompanying displays that would benefit from the present invention in such a context. In this regard, the present invention could be implemented in any one of a number of different contexts without departing from the spirit and scope of the present invention. For example, the present invention could be implemented for improving treatment of any number of different diseases.

Referring to FIG. 7, the request processing elements are capable of displaying a medical report relating to at least one HIV patient, such as an electronic genotype report 100, including at least a portion of medical information stored in the databases. In this regard, the genotype report includes patient information, as well as results 102 from a genotype test performed on a specimen taken from the particular patient. The medical information can be referenced in the database in any one of a number of different manners but, in one embodiment, the medical information is associated with a specimen identifier 104, which can be included on the genotype report.

To enable the user to seek additional information, such as an expert medical consultation and/or pharmaceutical product information, the genotype report 100 includes an expert consult pointer 106. When executed, the expert consult pointer allows the user to request a medical consultation directly from the genotype report. In this regard, the expert consult pointer identifies and is associated with at least one expert consult request form. Although the expert consult pointer of the illustrated embodiment comprises a hypertext link, the expert consult pointer can comprise any of a number of different elements, including any of a number of different types of defined “hot spots,” hyperlinks or the like.

Similar to the expert consult pointer 106, the genotype report 100 includes at least one pharmaceutical pointer 108 that, when executed, allows the user to view pharmaceutical information regarding at least one pharmaceutical drug. In this regard, the pharmaceutical pointers identify and are associated with at least one pharmaceutical product report, which is associated with pharmaceutical information for at least one pharmaceutical drug. In the illustrated embodiment, the pharmaceutical pointers comprise hypertext links identifying the trade name and/or generic name for the particular pharmaceutical drugs. It should be understood, however, that the pharmaceutical pointers can comprise any number of different elements, including any one of a number of different defined “hot spots,” hyperlinks or the like.

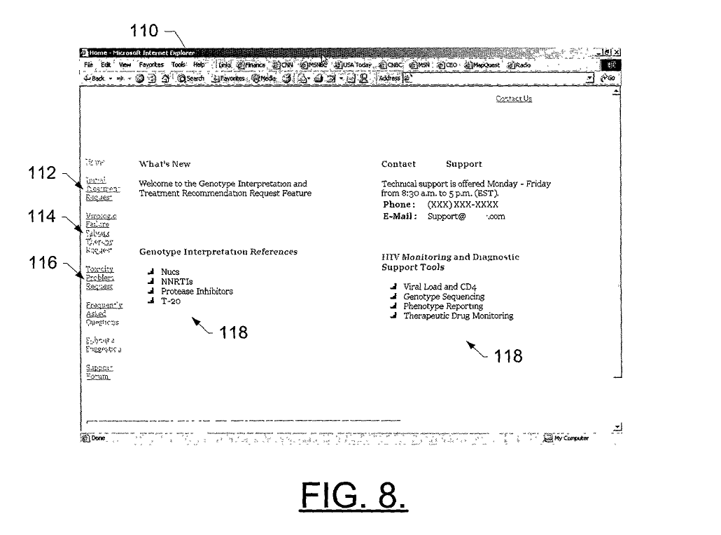

Referring now to FIG. 8, when the expert consult pointer 106 is executed, the respective request processing element is capable of displaying at least one expert consult request form. The request processing element can directly display the respective expert consult request form or, in embodiments such as that illustrated, the request processing element can display an electronic request form portal 110 upon execution of the expert consult pointer. In these embodiments, the expert consult pointer identifies and is associated with the electronic request form portal. The electronic request form portal includes request form pointers, which identify and are associated with expert consult request forms. For example, in the illustrated embodiment, the electronic request form portal includes an initial treatment request form pointer 112, a virologic failure salvage therapy request form pointer 114 and a toxicity problem request form pointer 116. In addition to the request form pointers, the electronic request form portal can include additional pointers 118, such as pointers identifying and associated with supplemental information respecting the expert consult request forms and/or the genotype report.

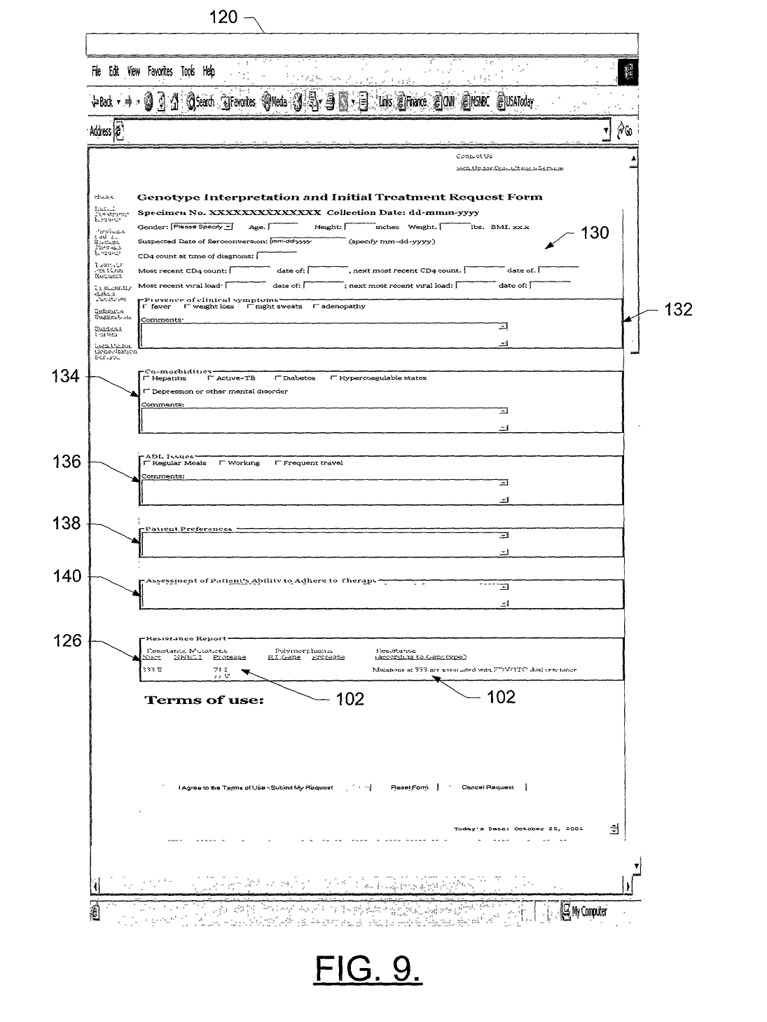

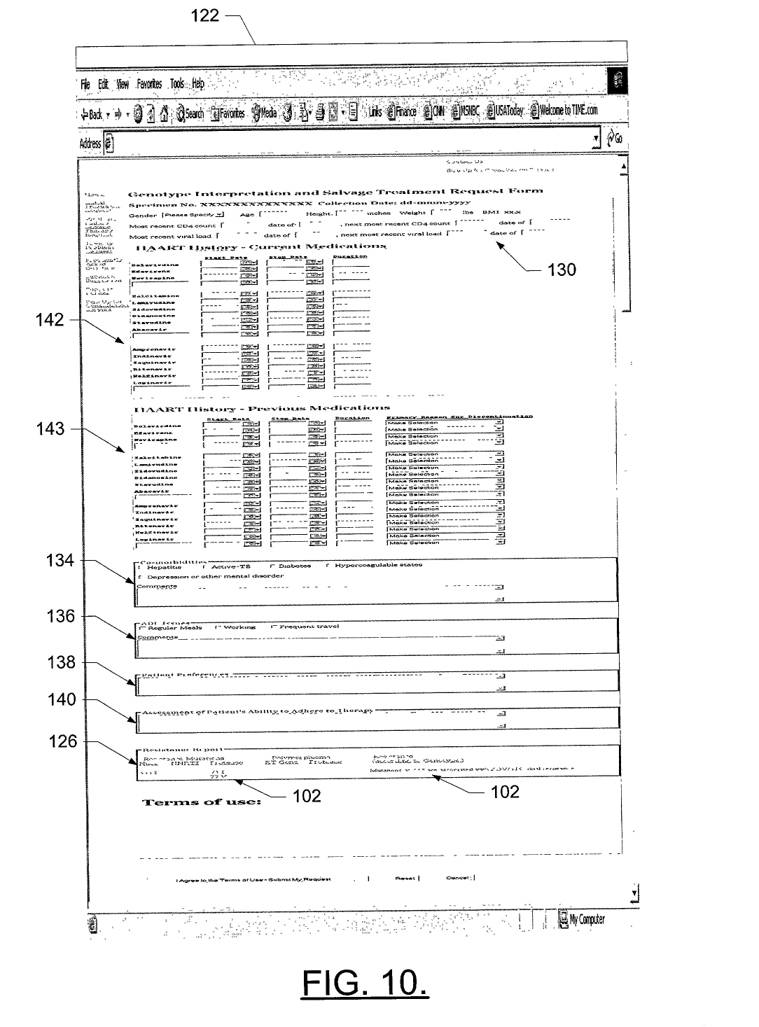

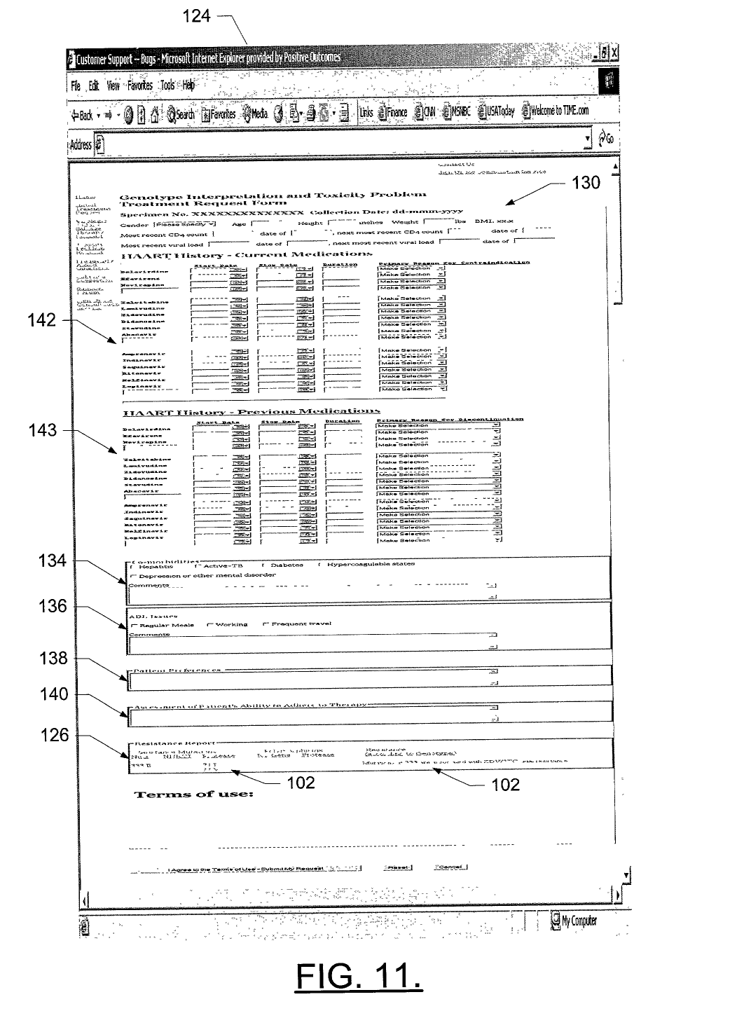

Referring to FIGS. 9-11, upon execution of a request form pointer, the respective request processing element can display a respective expert consult request form based upon the request form pointer executed, which can vary based upon the type of medical consultation desired by the user. For example, by executing the initial treatment request form pointer 112, the request processing element can display an initial treatment expert consult request form 120 (FIG. 9). By executing the virologic failure salvage therapy request form pointer 114, the request processing element can display a virologic failure salvage therapy expert consult request form 122 (FIG. 10). By executing the toxicity problem request form pointer 116, the request processing element can display a toxicity problem expert consult request form 124 (FIG. 11).

Each expert consult request form generally includes a medical information field 126 and at least one input field. Upon display of an expert consult request form, the respective request processing element can retrieve at least a portion of the medical information contained within the genotype report 100 from the respective databases, such as by referencing medical information associated with the specimen identifier 104 included on the genotype report. After retrieving the medical information, the request processing element can automatically populate the medical information field with the medical information 102 retrieved from the databases.

In addition to the medical information field 126, the expert consult request forms include input fields. The request processing elements are capable of receiving additional information into the input fields, such as patient information, that can be used to supplement the medical information populated into the medical information field. As previously stated, as used herein unless specified otherwise, the request processing elements, as well as the expert processing elements and server processing elements, receive information via an input device to the respective processing element, such as a keyboard, mouse, PDA or the like. The additional information can include information not stored within the databases, as well as information more up-to-date than that stored in the databases. For example, referring to the initial treatment expert consult request form illustrated in FIG. 9, the request processing element is capable of receiving information such as patient information 130, information relating to the presence of clinical symptoms 132, co-morbidities information 134, Activities of Daily Living (ADL) issues information 136, patient preferences information 138 and information relating to the treating physician's assessment of the patient's ability to adhere to therapy 140. In addition to the aforementioned input fields, referring to the virologic failure salvage therapy expert consult request form 122 (FIG. 10) and the toxicity problem expert consult request form 124 (FIG. 11), the request processing element is further capable of receiving information such as HAART history—present medications information 142 and HAART history—previous medications information 143.

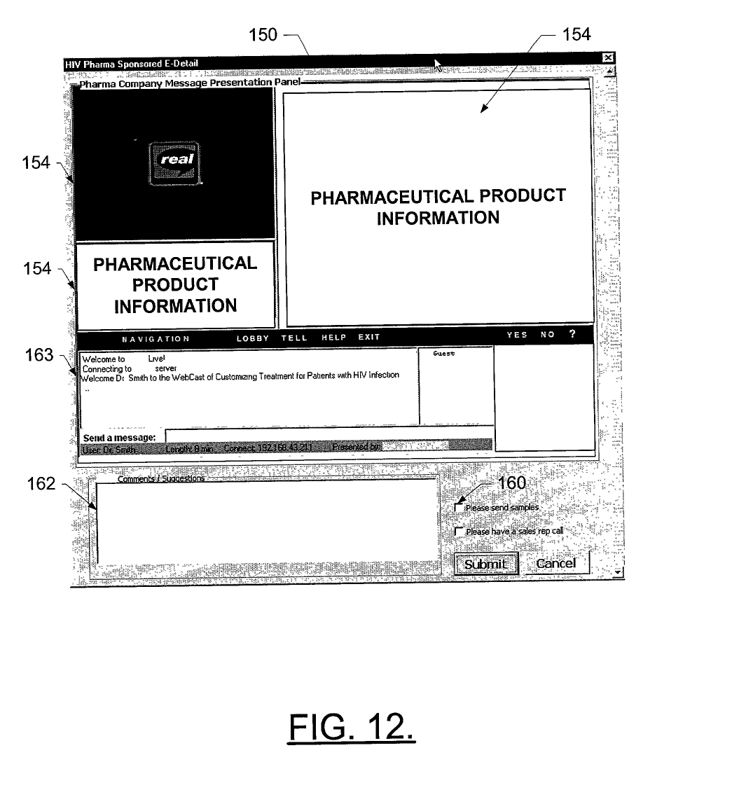

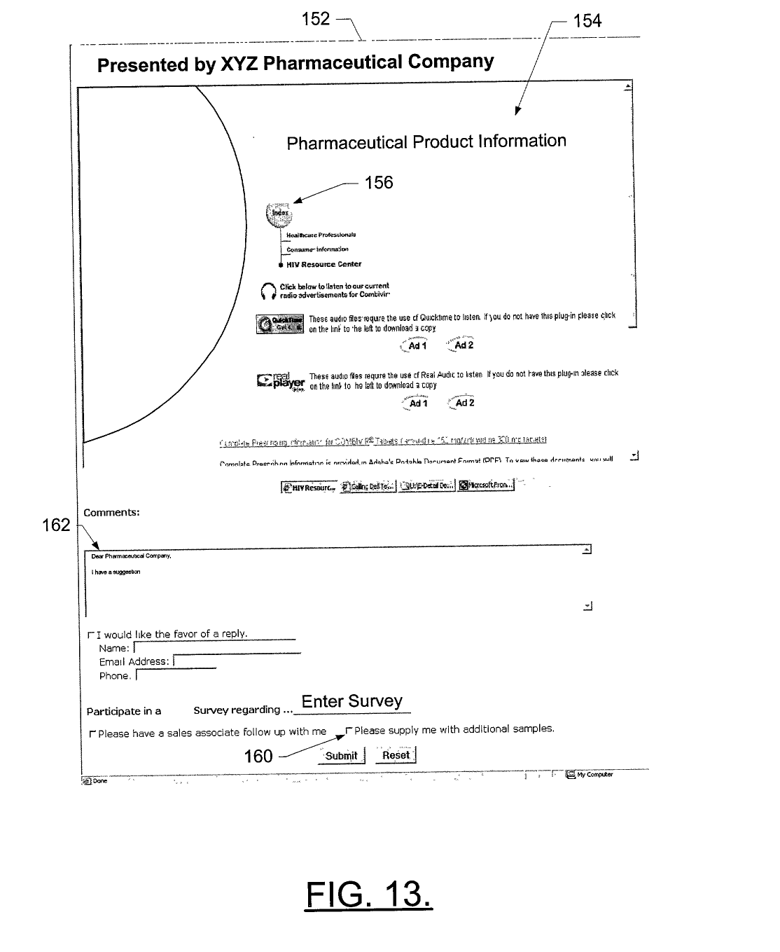

Referring to FIGS. 12 and 13, when at least one pharmaceutical pointer 108 is executed, the respective request processing element is capable of displaying a respective pharmaceutical product report 150, 152, which is associated with pharmaceutical information for at least one pharmaceutical drug. In this regard, the pharmaceutical product report generally includes at least one pharmaceutical product information field 154 that includes at least a portion of the associated pharmaceutical information. For example, by executing the pharmaceutical pointer “Delavirdine,” the request processing element displays the pharmaceutical product report associated with information relating to the pharmaceutical drug Delavirdine. Additionally, or alternatively, the pharmaceutical product information fields can include at least one product information pointer 156 that identifies and is associated with electronic pharmaceutical documents that contain further pharmaceutical information (not shown).

To display the pharmaceutical information within the pharmaceutical product information fields 154, the respective request processing element retrieves the pharmaceutical information from databases for a pharmaceutical product associated with the pharmaceutical product report. The request processing element can retrieve the portion of the pharmaceutical information solely based upon the respective pharmaceutical pointer 108 executed. In one advantageous embodiment, however, the request processing element retrieves the portion of the pharmaceutical information further based upon the medical information contained within the genotype report 100, such as via the specimen identifier 104 associated with the respective genotype report and identifying the medical information. As such, the pharmaceutical information retrieved is specific to the medical information contained within the medical report, such as pharmaceutical information specific to genetic mutation information included within the genotype report.

After retrieving the portion of the pharmaceutical information, the respective request processing element is capable of displaying the respective portion of pharmaceutical information in the pharmaceutical product information fields 154 of the pharmaceutical product report 150, 152. In one typical scenario, the pharmaceutical information is retrieved from a database located proximate or otherwise under the control of a particular pharmaceutical company. In addition to the pharmaceutical product information fields 154, the pharmaceutical product report can include at least one input field. The request processing elements are capable of receiving input information into the input fields, such as request or feedback information that can be used to by a treating physician and/or pharmaceutical company. For example, the input fields are capable of receiving requests by treating physicians for product samples 160, as wells as comments from a physician 162. Also, for example, the input fields can include an interactive chat session 163 whereby a physician can ask questions and/or provide feedback to an operator in real-time.

Upon receiving the input information into the input fields of the pharmaceutical product report, the respective request processing element can store the input information, such as in any one of a number of known memory devices, for later use or transfer. Additionally, or alternatively, the request processing element can automatically transmit the input information after receiving the input information. In this regard, the request processing element is capable of transmitting the input information to any one of a number of locations, including the databases storing the respective pharmaceutical information and/or other databases, such as those maintained by a third party.

To allow the user to seek an expert medical consultation to facilitate treatment of a respective patient, the request processing element is capable of transmitting a completed expert consult request form. The completed expert consult request form includes the medical information 102 populated into the medical information field 126 and, if received, the additional information in the input fields 128 and 134-142. The completed expert consult request form can be transmitted either directly or indirectly to one or more expert processing elements which, in one typical scenario, are located proximate or otherwise under the control of one or more medical experts.

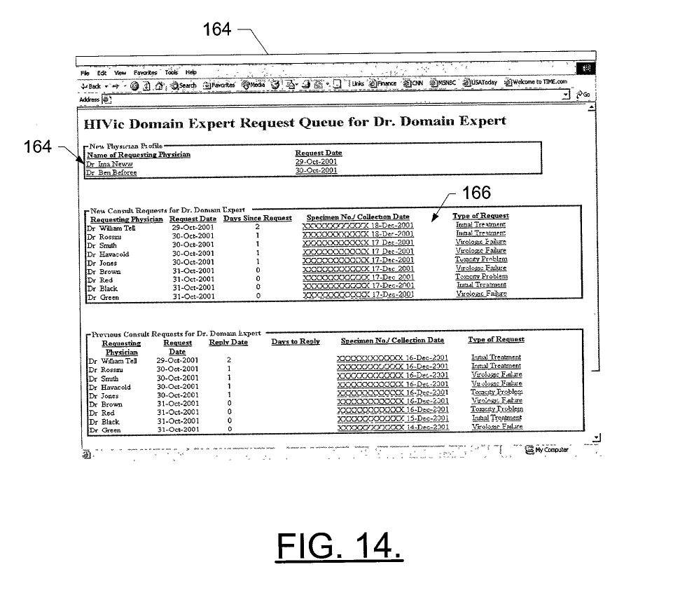

Upon receipt of the completed expert consult request form, the respective expert processing element facilitates a medical consultation based at least partially upon the completed expert consult request form. In this regard, the expert processing element is capable of displaying at least one medical consultation form based upon the completed expert consult request form. In one scenario where an expert processing element receives multiple completed expert consult request forms, the expert processing element is capable of displaying an electronic expert consultation portal 164, as shown in FIG. 14.

The electronic expert consultation portal 164 generally includes at least one medical consultation pointer 166 that identifies and is associated with respective completed expert consult request forms. For example, in the illustrated embodiment, the electronic expert consultation portal includes medical consultation pointers that identify a respective specimen identifier and type of request associated with the respective completed expert consult request form. The medical consultation pointers of the illustrated embodiment comprise hypertext links identifying the specimen identifier and/or type of request for the particular completed expert consult request form. However, it should be understood that the medical consultation pointers can comprise any number of different elements, including any one of a number of different defined “hot spots,” hyperlinks or the like.

In addition to the medical consultation pointers 166, the electronic expert consultation portal 164 can include further information associated with each medical consultation pointer and, thus, the completed expert consult request forms. In this regard, the electronic expert consultation portal can include information such as the name of the requesting physician that completed and/or transmitted the respective completed expert consult request form, the date the respective expert processing element received the request and the number of days since the expert processing element received the request. Further, the electronic expert consultation portal can break down the medical consultation pointers according to whether the medical consultation pointer is associated with a new completed expert consult request form or a previous completed expert consult request form, such as a completed expert consult request form that has already been displayed or otherwise used by the respective expert processing element.

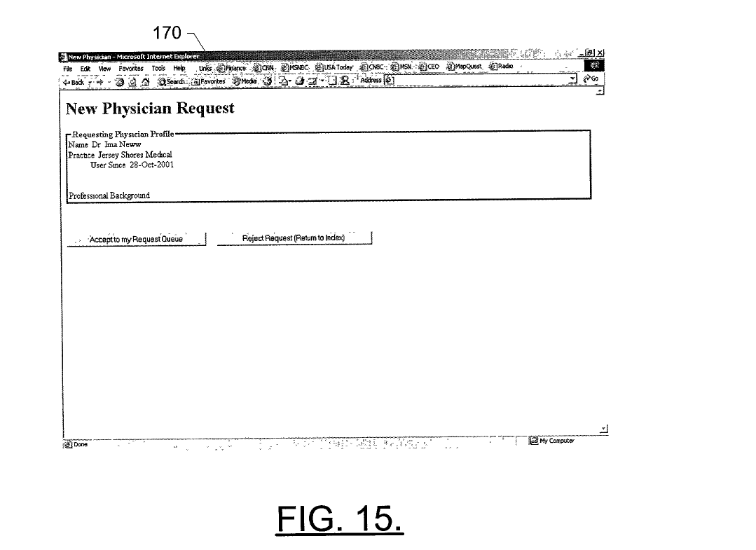

In one preferred embodiment, it is desirous for the user of the respective expert processing element to approve a new user and/or the request processing element of a new user before accepting a completed expert consult request form from the new user and/or the request processing element of the new user. As such, the user of the expert processing element is capable of determining whether the new user and/or treating physician meets desired qualifications of a requesting user and/or treating physician, such as desired professional qualifications. To allow the user of the expert processing element to review the new user and/or treating physician, the electronic expert consultation portal 164 can include at least one profile pointer 168 that, when executed, displays an electronic profile 170 of the new user and/or treating physician, as shown in FIG. 15. In this regard, the electronic profile includes information respecting the requesting user and/or treating physician. Based upon the information included on the electronic profile, the user of the expert processing element can determine whether or not to accept the respective completed expert consult request form.

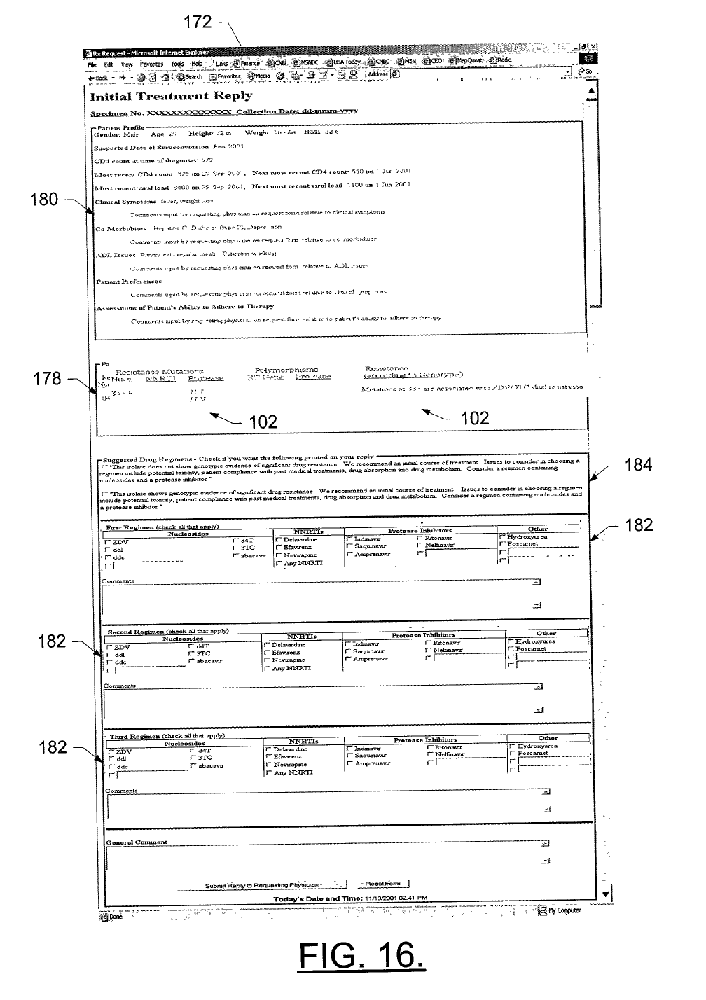

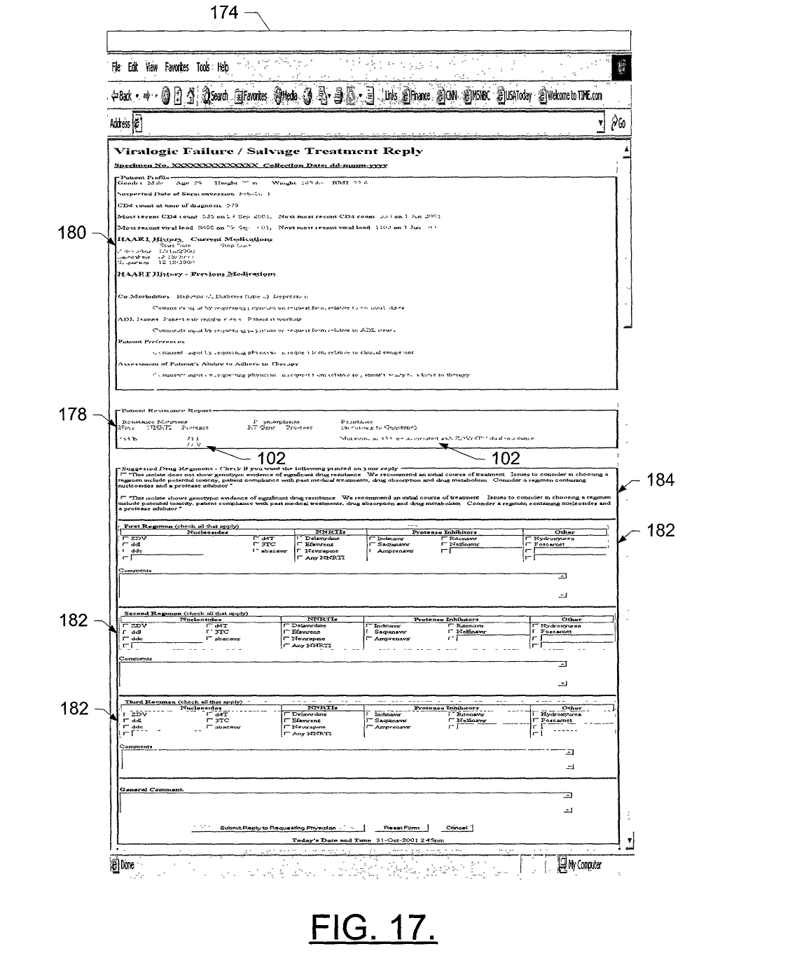

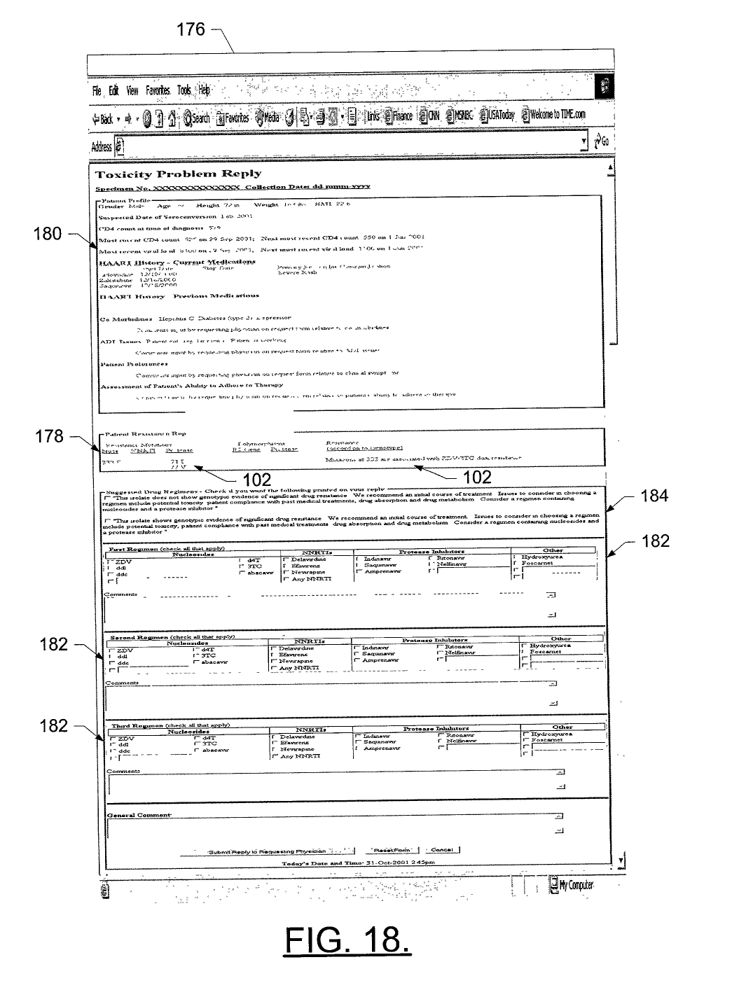

Now referring to FIGS. 16-18, either upon execution of a medical consultation pointer 166, or upon accepting a new user and/or request processing element of a new user, the respective expert processing element is capable of displaying one or more medical consultation forms based upon associated completed expert consult request forms. For example, the expert processing element can display an initial treatment medical consultation form 172 (FIG. 16), a virologic failure salvage therapy medical consultation form 174 (FIG. 17) and/or a toxicity problem medical consultation form 176 (FIG. 18). Generally, the medical consultation forms include at least one information field. For example, the medical consultation forms can include one information field 178 that contains the portion of the medical information 102 from the completed expert consult request form, as well as an information field 180 containing additional information received by the request processing element.

The medical consultation forms 172, 174 and 176 also include at least one consultation input field. The consultation input fields allows the user, such as a medical expert, to give a medical consultation based upon the medical information and additional information contained within the information fields 178 and 180. In this regard, the consultation input fields can include an input field 182 for each of a number of suggested drug regimens, and can additionally include an input field 184 for an optional header regarding the suggested drug regimens.

Once the respective expert processing element has received the consultation information the medical consultation form is complete. The expert processing element is capable of transmitting the completed medical consultation form. In this regard, one or more request processing elements, such as those originally transmitting the respective completed electronic expert consult forms, receive the completed medical consultation form. Additionally or alternatively, one or more server processing elements can receive the completed medical consultation form which and, thereafter, transmit the completed expert consult request form to the request processing elements. As such, in either event, upon receipt of the completed medical consultation form, the user of the request processing element is thereby provided with a medical consultation based at least partially upon the completed expert consult request form.

In one advantageous embodiment, portions of the system and method of the present invention, such as portions of the request processing element 12 and the expert processing element 14, include a computer program product. The computer program product includes a computer-readable storage medium, such as the nonvolatile storage medium, and computer-readable program code portions, such as a series of computer instructions, embodied in the computer-readable storage medium. Typically, the computer program is stored by the respective processing element or a related memory device, such as a non-volatile storage device, and is executed by the respective processing element.

In this regard, FIGS. 1-6 are block diagrams, schematic illustrations, flowcharts and control flow illustrations of methods, systems and program products according to the invention. It will be understood that each block or step of the block diagram, flowchart and control flow illustration, and combinations of blocks in the block diagram, flowchart and control flow illustration, can be implemented by computer program instructions. These computer program instructions may be loaded onto a computer or other programmable apparatus to produce a machine, such that the instructions which execute on the computer or other programmable apparatus create means for implementing the functions specified in the block diagram, flowchart or control flow block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the block diagram, flowchart or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

Accordingly, blocks or steps of the block diagram, flowchart or control flow illustration support combinations of means for performing the specified functions, combinations of steps for performing the specified functions and program instruction means for performing the specified functions. It will also be understood that each block or step of the block diagram, flowchart or control flow illustration, and combinations of blocks or steps in the block diagram, flowchart or control flow illustration, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for improving treatment of medical patients comprising:
at least one request processing element comprising a patient medical report including medical information, said patient medical report being associated with at least one expert consult request form, wherein the at least one expert consult request form is accessible directly from said patient medical report, and wherein said at least one request processing element is capable of populating the at least one expert consult request form with a portion of the medical information from said patient medical report; and
at least one expert processing element capable of receiving the at least one expert consult request form to thereby facilitate a medical consultation at least partially based upon the at least one expert consultation request form.

2. A system according to claim 1, wherein said patient medical report further includes at least one expert consult pointer that is associated with the at least one expert consult request form, and wherein said at least one request processing element is responsive to a selection of the at least one expert consult pointer to thereby display the associated at least one expert consult request form and populate the associated expert consult request form with the portion of the medical information from said patient medical report.

3. A system according to claim 2, wherein the at least one expert consult request form includes at least one medical information field, wherein said at least one request processing element is responsive to a selection of the at least one expert consult pointer to thereby display the associated at least one expert consult request form and automatically populate the at least one medical information field with the portion of the medical information.

4. A system according to claim 2, wherein the at least one expert consult request form includes at least one input field, wherein said at least one expert processing element is capable of receiving patient information into the at least one input field, and wherein the at least one completed expert consult request form is further based upon the patient information received into the at least one expert consultation request form.

5. A system according to claim 1, wherein said request processing element is capable of transmitting the at least one expert consult request form to said at least one expert processing element.

6. A system according to claim 1, wherein said at least one expert processing element is capable of displaying at least one medical consultation form based upon the at least one expert consult request form, wherein said at least one expert processing element is capable of receiving consultation information into the at least one medical consultation form to complete the at least one medical consultation form, and wherein said at least one expert processing element is capable of transmitting the at least one completed medical consultation form to thereby provide the medical consultation.

7. A system according to claim 6, wherein the at least one medical consultation form includes the portion of the medical information from said patient medical report.

8. A system according to claim 1 further comprising at least one database capable of storing the medical information, wherein said at least one request processing element is capable of retrieving the medical information from said at least one database.

9. A system according to claim 1, wherein said patient medical report is further associated with at least one pharmaceutical product report including pharmaceutical information for at least one pharmaceutical product, wherein the at least one pharmaceutical product report is accessible directly from said patient medical report.

10. A system according to claim 9, wherein said patient medical report further includes at least one pharmaceutical pointer that is associated with the at least one pharmaceutical product report, and wherein said at least one request processing element is responsive to a selection of the at least one pharmaceutical pointer to thereby display the at least one pharmaceutical product report including at least a portion of the pharmaceutical information.

11. A system according to claim 10 further comprising at least one database capable of storing the pharmaceutical information, wherein said at least one request processing element is responsive to a selection of the at least one pharmaceutical pointer to thereby retrieve at least a portion of the pharmaceutical information from said at least one database and thereafter display the at least one pharmaceutical product report.

12. A system according to claim 9, wherein the at least one pharmaceutical product report includes at least one input field, wherein said at least one request processing element is capable of receiving input information into the at least one input field, and wherein said at least one request processing element is capable of transmitting the input information.

13. A system according to claim 9, wherein the at least one pharmaceutical product report is associated with pharmaceutical information for at least one pharmaceutical product comprising at least one of marketing information and reference information.

14. A system for improving treatment of medical patients comprising:
at least one request processing element comprising a patient medical report including medical information, said patient medical report being associated with at least one pharmaceutical product report including pharmaceutical information for at least one pharmaceutical product, wherein the at least one pharmaceutical product report is accessible directly from said patient medical report; and
at least one database capable of storing the pharmaceutical information, wherein said at least one request processing element is capable of retrieving at least a portion of the pharmaceutical information from said at least one database as the at least one pharmaceutical product report is accessed.

15. A system according to claim 14, wherein said patient medical report further includes at least one pharmaceutical pointer that is associated with the at least one pharmaceutical product report, and wherein said at least one request processing element is responsive to a selection of the at least one pharmaceutical pointer to thereby retrieve a respective portion of the pharmaceutical information and display the respective pharmaceutical product report.

16. A system according to claim 14, wherein said request processing element is capable of receiving information into the at least one pharmaceutical product report, and wherein said at least one request processing element is capable of at least one of storing the information and transmitting the information.

17. A system according to claim 14, wherein the at least one pharmaceutical product report is associated with pharmaceutical information for at least one pharmaceutical product comprising at least one of marketing information and reference information.

18. A system according to claim 14, wherein said patient medical report is further associated with at least one expert consult request form, wherein the at least one expert consult request form is accessible directly from said patient medical report, and wherein said at least one request processing element is capable of populating the at least one expert consult request form with a portion of the medical information from said patient medical report, said system further comprising:
at least one expert processing element capable of receiving the at least one completed expert consult request form to thereby facilitate a medical consultation at least partially based upon the at least one expert consultation request form.

19. A system according to claim 18, wherein said patient medical report further includes at least one expert consult pointer that is associated with the at least one expert consult request form, and wherein said at least one request processing element is responsive to a selection of the at least one expert consult pointer to thereby display the associated at least one expert consult request form and populate the associated expert consult request form with the portion of the medical information from said patient medical report.

20. A system according to claim 18, wherein said request processing element is capable of transmitting the at least one expert consult request form to said at least one expert processing element.

21. A system according to claim 18, wherein said at least one expert processing element is capable of displaying the at least one medical consultation form, wherein said at least one expert processing element is capable of receiving consultation information into the at least one medical consultation form to thereby complete the at least one medical consultation form, and wherein said at least one expert processing element is capable of transmitting the at least one completed medical consultation form to thereby provide the medical consultation.

22. A system according to claim 21, wherein the at least one medical consultation form includes the portion of the medical information from said medical report.

23. A system according to claim 18 wherein said at least one database is further capable of storing the medical information, wherein said at least one request processing element is capable of retrieving the portion of the medical information of said medical report from said database.

24. A method of improving treatment of medical patients comprising:
displaying a patient medical report including medical information, the patient medical report being associated with at least one expert consult request form;
accessing the at least one expert consult request form directly from the patient medical report that is displayed, wherein accessing the at least one expert consult request form includes populating the at least one expert consult request form with at least a portion of the medical information from the patient medical report that is displayed;
transmitting the at least one expert consult request form that is accessed and thereafter receiving the at least one expert consult request form; and
generating a medical consultation at least partially based upon the received expert consult request form.

25. A method of improving treatment of medical patients comprising:
displaying a patient medical report including medical information, the patient medical report being associated with at least one pharmaceutical product report that includes pharmaceutical information for at least one pharmaceutical product;
accessing the at least one pharmaceutical product report thereafter retrieving at least a portion of the associated pharmaceutical information; and
displaying the at least one pharmaceutical product report including the retrieved portion of the associated pharmaceutical information.

26. A computer program product for improving treatment of medical patients, the computer program product comprising a computer-readable storage medium having computer-readable program code embodied in said medium, the computer-readable program code comprising:
a first executable portion for displaying a patient medical report including medical information, the patient medical report being associated with at least one expert consult request form;
a second executable portion for accessing the at least one expert consult request form directly from the patient medical report that is displayed, wherein accessing the at least one expert consult request form includes populating the at least one expert consult request form with at least a portion of the medical information from the patient medical report that is displayed;
a third executable portion for transmitting the accessed at least one expert consult request form; and
a fourth executable portion for receiving the accessed at least one expert consult request form and thereafter generating a medical consultation at least partially based upon the accessed at least one expert consult request form.

27. A computer program product for improving treatment of medical patients, the computer program product comprising a computer-readable storage medium having computer-readable program code embodied in said medium, the computer-readable program code comprising:
a first executable portion for displaying a patient medical report including medical information, the patient medical report being associated with at least one pharmaceutical product report that includes pharmaceutical information for at least one pharmaceutical product;
a second executable portion for accessing the at least one pharmaceutical product report thereafter retrieving at least a portion of the associated pharmaceutical information; and
a third executable portion for displaying the at least one pharmaceutical product report including the retrieved portion of the associated pharmaceutical information.

28. A system for improving treatment of medical patients comprising:
at least one request processing element capable of displaying a patient medical report including medical information and at least one expert consult pointer that is associated with at least one expert consult request form, wherein said at least one request processing element is responsive to a selection of the at least one expert consult pointer to thereby display the associated at least one expert consult request form, wherein said at least one request processing element is capable of retrieving at least a portion of the medical information and thereafter populating the at least one expert consult request form with the portion of the medical information, wherein said at least one request processing element is capable of transmitting at least one completed expert consult request form, and wherein the at least one completed expert consult form is based upon the portion of the medical information populated into the at least one expert consultation request form; and
at least one expert processing element capable of receiving the at least one completed expert consult request form to thereby facilitate a medical consultation at least partially based upon the at least one completed expert consultation request form.

29. A system for improving treatment of medical patients comprising:
at least one request processing element capable of displaying a patient medical report including medical information and at least one pharmaceutical pointer that identifies and is associated with at least one electronic pharmaceutical product report, wherein the at least one electronic pharmaceutical product report is associated with pharmaceutical information for at least one pharmaceutical product, wherein the at least one pharmaceutical product report includes at least one input field, wherein said at least one request processing element is responsive to a selection of at least one pharmaceutical pointer to thereby retrieve at least a portion of the associated pharmaceutical information and thereafter display the at least one pharmaceutical product report with the portion of the pharmaceutical product information, and wherein said at least one request processing element is capable of receiving information input into the at least one input field of the pharmaceutical product report; and
at least one database capable of storing the pharmaceutical information, wherein said at least one request processing element is responsive to a selection of the at least one pharmaceutical pointer to thereby retrieve at least a portion of the associated pharmaceutical information from said at least one database and thereafter display the at least one pharmaceutical product report.
